(19) United States
(12) Patent Application Publication
(10) Pub. No.: US 2026/0084775 A1
(43) Pub. Date: Mar. 26, 2026

(54) MOBILITY VEHICLE

(71) Applicant: Rhom, Inc., Merritt Island, FL (US)

(72) Inventors: Bradley Michael Menden, Merritt Island, FL (US); Brent Michael Molitor, Zimmerman, MN (US)

(21) Appl. No.: 19/337,801

(22) Filed: Sep. 23, 2025

Related U.S. Application Data
(60) Provisional application No. 63/697,885, filed on Sep. 23, 2024.

(51) Int. Cl. B62K 5/007; B62K 5/08

(52) U.S. Cl. CPC B62K 5/007; B62K 5/08

(57) ABSTRACT

A mobility vehicle includes a front deck and a rear deck. One or more motors are operably coupled to one or more of at least one front ground engaging member and at least one rear ground engaging member to provide powered movement. The front deck is pivotally coupled to the rear deck by a joint about a pivot axis that is orthogonal to both the direction of travel and the ground surface. Further, the front deck is rollably coupled to the rear deck by a joint about a roll axis that is substantially parallel to the ground surface. A steerable member is operatively connected to the front deck and configured to pivot the front deck relative to the rear deck by an operator on the operator platform to steer the vehicle.

This application claims the benefit of U.S. Provisional Application No. 63/697,885 filed Sep. 23, 2024, and entitled “Mobility Vehicle,” which is incorporated by reference in its entirety.

The present disclosure generally relates to mobility vehicles.

Mobility vehicles, or machines, have become increasingly popular for personal transportation, recreation, and utility applications. These vehicles typically include various configurations of wheels, motors, and control systems that enable users to traverse different types of terrain and surfaces. Traditional mobility vehicles often employ rigid frame designs that connect front and rear sections in a fixed relationship, which can limit their ability to navigate uneven or challenging terrain conditions.

Many mobility vehicles are designed for specific surface types, such as smooth pavement or prepared pathways. However, users frequently encounter varied terrain conditions that include slopes, uneven surfaces, obstacles, and changes in surface texture or composition. The ability to maintain stability and control while traversing such diverse conditions presents ongoing challenges in mobility vehicle design.

Existing mobility vehicles may experience limitations in their maneuverability and adaptability when encountering terrain variations. Some designs incorporate suspension systems or flexible mounting arrangements to address these challenges, but these solutions often add complexity, weight, or maintenance requirements to the vehicle system.

The control and steering mechanisms of mobility vehicles also present design considerations. Various approaches have been developed to enable user control of vehicle direction and movement, including handlebar systems, weight-shift mechanisms, and electronic control interfaces. The integration of these control systems with the vehicle's mechanical structure affects both the user experience and the vehicle's performance characteristics.

Power systems for mobility vehicles have evolved to include electric motors and battery systems that provide propulsion for one or more wheels. The placement and configuration of these power systems within the vehicle structure influences factors such as weight distribution, balance, and overall vehicle performance across different operating conditions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some configurations, a mobility vehicle, or machine, to move over a ground surface in a direction of travel is provided. The mobility vehicle includes a front deck including at least one front ground engaging member and a rear deck including at least one rear ground engaging member and an operator platform. The mobility vehicle includes one or more motors operably coupled to one or more of the at least one front ground engaging member and the at least one rear ground engaging member to provide powered movement using one or more of the at least one front ground engaging member and the at least one rear ground engaging member. The mobility vehicle includes a joint operatively connecting the front deck and the rear deck, and the front deck is pivotally coupled to the rear deck about a pivot axis that is orthogonal to both the direction of travel and the ground surface. The joint may have a pivot range about the pivot axis between the front deck and the rear deck is limited to less than 270 degrees. The front deck is rollably coupled to the rear deck about a roll axis that is substantially parallel to the ground surface and a roll range about the roll axis between the front deck and the rear deck is limited to less than 270 degrees. The mobility vehicle includes a steerable member operatively connected to the front deck and configured to pivot the front deck relative to the rear deck by an operator on the operator platform to steer the vehicle.

In another embodiment, the mobility vehicle, or machine, may include a pivot range may be limited to less than 70 degrees and the roll range may be limited to less than 50 degrees. The joint may includes an upper linkage and a lower linkage, and each of the upper linkage and the lower linkage may be operatively coupled to both the front deck and the rear deck. The upper linkage may be fixedly connected to the front deck and pivotally and rollably connected to the rear deck, and the lower linkage may be pivotally and rollably connected to the front deck and pivotally and rollably connected to the rear deck. The mobility vehicle may further include a front support arm coupled to the front deck and the steerable member. The mobility vehicle may further include at least one damper operatively connected to the front deck and the rear deck to reduce a rate of pivotal movement between the front deck and the rear deck about the pivot axis. The one or more motors may include one or more an electric motor, an internal combustion motor, and a hydraulic motor. In one embodiment, the one or more motors include two electrical motors: one rear electric motor; and one front electric motor. The one or more motors may include a front motor operably coupled to the at least one front ground engaging member to provide powered movement using the at least one front ground engaging member. The one or more motors may include a rear motor operably coupled to the at least one rear ground engaging member to provide powered movement using the at least one rear ground engaging member.

In another embodiment, a mobility vehicle, or machine, to move over a ground surface in a direction of travel is provided. The mobility vehicle includes a front deck including at least one front ground engaging member. The mobility vehicle includes a rear deck including at least one rear ground engaging member and an operator platform. The mobility vehicle includes one or more motors operably coupled to one or more of the at least one front ground engaging member and the at least one rear ground engaging member to provide powered movement using one or more of the at least one front ground engaging member and the at least one rear ground engaging member. The mobility vehicle includes a joint operatively connecting the front deck and the rear deck. The front deck is pivotally coupled to the rear deck about a pivot axis that is orthogonal to both the direction of travel and the ground surface. The front deck is rollably coupled to the rear deck about a roll axis that is substantially parallel to the ground surface. The joint includes an upper linkage and a lower linkage, and each of the upper linkage and the lower linkage operatively coupled to both the front deck and the rear deck. The mobility vehicle includes a steerable member operatively connected to the front deck and configured to pivot the front deck relative to the rear deck by an operator on the operator platform to steer the vehicle.

In another embodiment, the mobility vehicle, or machine, may include upper linkage may be fixedly connected to the front deck and pivotally and rollably connected to the rear deck, and the lower linkage may be pivotally and rollably connected to the front deck and pivotally and rollably connected to the rear deck. The upper linkage may be fixedly connected to the front deck and pivotally and rollably connected to the rear deck using an upper spherical bearing, and the lower linkage may be pivotally and rollably connected to the front deck using a lower front spherical bearing and pivotally and rollably connected to the rear deck using a lower rear spherical bearing. The upper linkage may be fixedly connected to the front deck and pivotally and rollably connected to the rear deck using an upper compliant bushing, and the lower linkage may be pivotally and rollably connected to the front deck using a lower front spherical bearing and pivotally and rollably connected to the rear deck using a lower compliant bushing. The steerable member may be configured operatively disconnected from front deck to move into a storage position. The steerable member may be pivotally coupled to the front deck to pivot into the storage position when operatively disconnected from front deck. The mobility vehicle may further include a front support arm coupled to the front deck and the steerable member. The mobility vehicle may further include at least one damper operatively connected to the front deck and the rear deck to reduce a rate of pivotal movement between the front deck and the rear deck about the pivot axis.

The foregoing general description of the illustrative embodiments and the following detailed description thereof are merely illustrative aspects of the teachings of this disclosure and are not restrictive.

### BRIEF DESCRIPTION OF FIGURES

Illustrative embodiments will be further described with reference to the figures of the drawings, wherein:

FIG. 1 illustrates a perspective view of a mobility vehicle, according to aspects of the present disclosure.

FIG. 2 illustrates a side view of the mobility vehicle of FIG. 1, according to aspects of the present disclosure.

FIG. 3 illustrates a top view of the mobility vehicle of FIG. 1, according to aspects of the present disclosure.

FIG. 4 illustrates a front view of the mobility vehicle of FIG. 1, according to aspects of the present disclosure.

FIG. 5 illustrates a front view of the mobility vehicle with a front deck rolled relative to a rear deck, according to aspects of the present disclosure.

FIG. 6 illustrates a top view of the mobility vehicle with the front deck pivoted relative to the rear deck, according to aspects of the present disclosure.

FIG. 7 illustrates a side view of the mobility vehicle in a storage configuration, according to aspects of the present disclosure.

FIG. 8 illustrates a perspective view of the mobility vehicle in the storage configuration, according to aspects of the present disclosure.

FIG. 9 illustrates a perspective view of the mobility vehicle with the front deck decoupled from the rear deck, according to aspects of the present disclosure.

FIG. 10 illustrates a perspective exploded view of the mobility vehicle, according to aspects of the present disclosure.

FIG. 11 illustrates a perspective exploded view of the mobility vehicle without wheels, according to aspects of the present disclosure.

FIG. 12 illustrates a perspective exploded view of a front portion of the mobility vehicle, according to aspects of the present disclosure.

FIG. 13 illustrates a perspective exploded view of a joint and dampers of the mobility vehicle, according to aspects of the present disclosure.

### DETAILED DESCRIPTION

In the following detailed description of illustrative embodiments, reference is made to the accompanying figures of the drawings which form a part thereof, and in which are shown, by way of illustration, specific embodiments which may be practices. It is to be understood that other embodiments my be utilized, and structural changes may be made without departing from (e.g., still falling within) the scope of the disclosure presented hereby.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est and means “that is.” “E.g.” is used as an abbreviation for the Latin phrase exempli gratia and means “for example.”

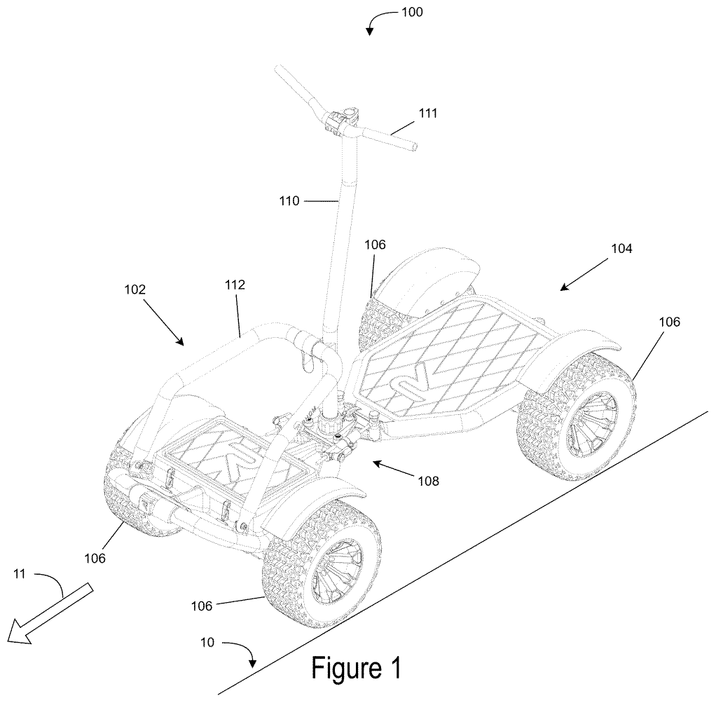

With reference to the figures of the drawings, wherein like reference numerals designate like parts and assemblies throughout the several views, FIG. 1 illustrates a mobility vehicle 100 in accordance with illustrative embodiments of the present disclosure. While shown in these views as a self-propelled, stand-on mobility vehicle 100 (also referred to herein as simply as a “vehicle”), such a configuration is not limiting. That is, while embodiments are described herein with respect to a stand on mobility vehicle 100, those skilled in the art will realize that this disclosure is equally applicable to other tiles of vehicles, (e.g., walk-behind or sit-on), as well as other types of wheeled or tracked mobility vehicles without limitations. That is to say, the terms “mobility vehicle” or “mobility machine” are understood herein to include mobility vehicles or machines intended for operation, indoors or outdoors, and upon either or both of turf (e.g., grass) and non-turf (e.g., concrete) surfaces.

It is noted that the terms “have,” “includes,” “comprises,” and variations thereof do not have a limiting meaning and are used in the open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like can be used herein and, if so, are from the perspective shown in the particular figure. These terms are used only to simplify the description, however, and not to limit the interpretation of any embodiment described. In a similar manner, terms such as “first” and “second” may be used herein to describe various elements. However, such terms are used merely to simplify identification of the element(s). Accordingly, if an element is described as “first,” there may or may not be subsequent elements—that is, a “second” element is not necessarily present. It is further understood that the description of any particular element as being operably attached, connected, or coupled to another element may indicate that the elements are either directly attached, connected, or coupled to one another, or are indirectly attached, coupled, or connected to one another via intervening elements.

An illustrative mobility vehicle shall be described with reference to FIGS. 1-13. It will be apparent to one skilled in the art that elements or processes from one embodiment may be used in combination with elements or processes of the other embodiments, and that the possible embodiments of such mobility vehicle using combination of features set forth herein is not limited to the specific embodiments shown in the Figures and/or described herein. Further, it will be recognized that the embodiments described herein my include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, my be advantageous over others.

Referring to FIG. 1, a mobility vehicle 100 may be configured to move over a ground surface 10 in a direction of travel 11. The mobility vehicle 100 includes a front deck 102 and a rear deck 104 that are operatively coupled to each other as will be described herein. The front deck 102 may include at least one front ground engaging member 106, while the rear deck 104 may include at least one rear ground engaging member 106 and an operator platform. Front deck 102 and rear deck 104 may be manufactured from various components and materials (e.g., plastic, metal, etc.). In one embodiment, the front deck 102 and the rear deck 104 are manufactured from plastic thermoforming which provides structural integrity while remaining lightweight. It is understood that front deck 102 and the rear deck 104 may be manufactured by any method known by one of ordinary skill in the art. The rear deck 104 may include an operator platform upon which an operator may stand to operate, or drive, the mobility vehicle 100. In one embodiment, the operator platform may include a seat upon which an operator may sit.

Ground engaging members may be interchangeable to allow adaptability of mobility vehicle 100 based on a plurality of operational scenarios. For example, ground engaging members 106 may be treaded wheels, as shown in FIG. 1, for general use. In another example, the ground engaging members 106 may be interchanged for tracks for use on lose soil or sand. In other embodiments, ground engaging members 106 are replaceable to account for normal wear. It is to be understood that ground engaging members 106 are not limited to wheels or tracks and can be any variety of members which when rotate will propel the mobility vehicle in the direction of travel.

And mobility vehicle 100 includes a joint 108 that operatively connects the front deck 102 and the rear deck 104 and provides movement between the front deck 102 and the rear deck 104 to allow the mobility vehicle to traverse a range of ground surfaces 10. For example, the joint provides a pivotal coupling between the rear deck 104 and the front deck 102. The pivotal coupling may allow pivotal movement between the front deck 102 and the rear deck 104 about a pivot axis 15 that is orthogonal to both the direction of travel 11 and the ground surface 10.

A steerable member 110 extends upwardly from the front deck 102 and may be operatively connected to the front deck 102. The steerable member 110 may be configured to pivot the front deck 102 relative to the rear deck 104 by an operator positioned on the operator platform to steer the mobility vehicle 100 by pivoting the front deck 102 relative to the rear deck 104.

In one example, the mobility vehicle 100 further includes a front support arm 112 that is configured to provide support to the steerable member 110 by way of connections between the front deck 102 and the steerable member 110. The front support arm 112 may be connected to the front deck 102 via a pivot joint which, in one example, allows for adjustment or flex between the front deck 102 and the steerable member 110 and a storage configuration.

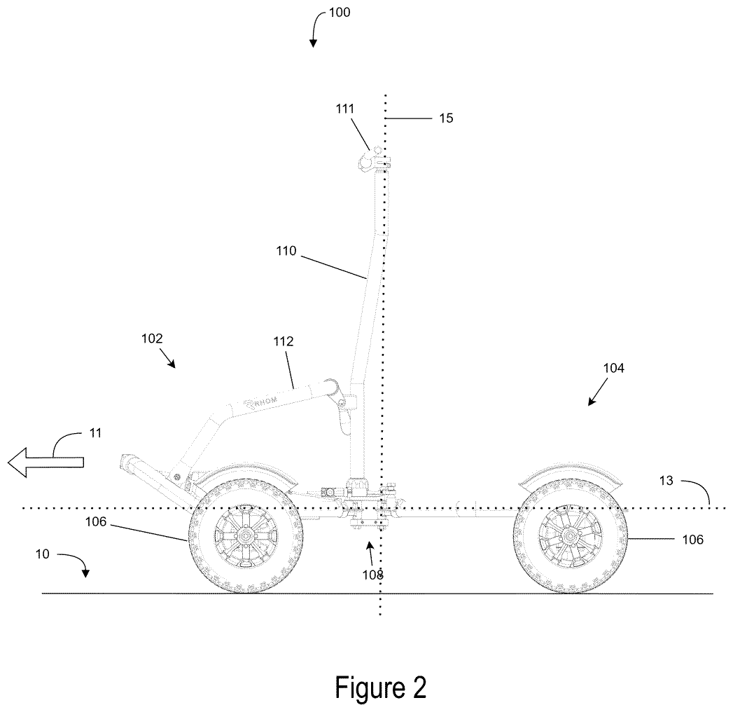

Referring to FIG. 2, the side view of the mobility vehicle 100 illustrates the structural arrangement of the components along the direction of travel 11. The front deck 102 and the rear deck 104 may be described as being positioned in a linear configuration that extends from the front to the rear of the mobility vehicle 100 along a roll axis 13. The ground engaging members 106 are positioned forward and rearward and operationally coupled to each of the front deck 102 and rear deck 104, respectively, which defines the wheelbase of mobility vehicle 100. The joint 108 may be located at an intermediate position between the front deck 102 and the rear deck 104, creating a connection point that allows for articulation while maintaining structural continuity between the two decks 102, 104.

In this embodiment, the steerable member 110 extends substantially vertically upward from the front deck 102, creating a vertical profile that positions the steering interface above the ground engaging members 106. FIG. 2 illustrates, in one example, the steerable member 110 coupled to front deck 102 at the rear of the front deck 104 right in front of the joint 108 relative to the direction of travel 11. Steerable member 110 is coupled to an operator interface 111. FIG. 2 shows by way of example, operator interface 111 as a handlebar but may be a variety of other interfaces which allow an operator to rotate the steerable member 110. While steerable member 110 is depicted at the rear of front deck 102, it is understood that steerable member may be coupled to front deck 102 in any location optimal for steering control of mobility vehicle 100.

The height of the steerable member 110 may be configured to provide ergonomic access for an operator positioned on the rear deck 104. In one example, steerable member 110 may be angled toward the rear deck 104 to allow for better control by the operator. In another example, the steerable member 110 may be directly perpendicular to the front deck 102 and rear deck 104. The front support arm 112 extends between the front deck 102 and the steerable member 110. In some cases, the front support arm 112 may extend at an angle that provides both structural support and clearance for the operation of the front ground engaging members 106.

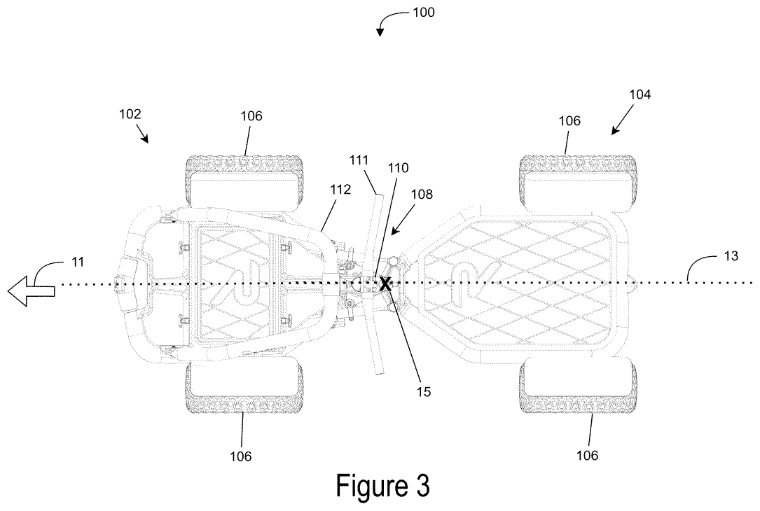

Referring to FIG. 3, the top view of the mobility vehicle 100. The front deck 102 and the rear deck 104 may be positioned in a longitudinal alignment that defines the overall length and width dimensions of the mobility vehicle 100. The ground engaging members 106 may be positioned at the corners of both the front deck 102 and rear deck 104, creating a rectangular or trapezoidal footprint that provides stability during operation.

The joint 108 may be located at an intermediate position between the front deck 102 and the rear deck 104, creating a connection point that allows for articulation while maintaining the structural relationship between the two deck sections. From the top view perspective, the joint 108 may appear as a central connection element that enables the front deck 102 to pivot relative to the rear deck 104 about a pivot axis 15. In some cases, the joint 108 may be positioned closer to the geometric center of the mobility vehicle 100 to optimize the pivotal movement characteristics between the front deck 102 and the rear deck 104.

The steerable member 110 may extend upward from the front deck 102 and may appear as a vertical element when viewed from above, with the front support arm 112 providing additional structural connection between the front deck 102 and the steerable member 110. The top view arrangement demonstrates how the steerable member 110 may be positioned to provide directional control over the front deck 102 while maintaining clearance from the ground engaging members 106 and other components. In some cases, the front support arm 112 may be positioned to avoid interference with the operation of the ground engaging members 106 and allow for space on the front deck 102 to allow for storage of items on the front deck 102. The front support arm 112 while providing structural support for steerable member 110 may also provide a support boundary for front deck 102 to allow for storage and transport of items (e.g., golf clubs, fishing rods, etc.) on the front deck 102.

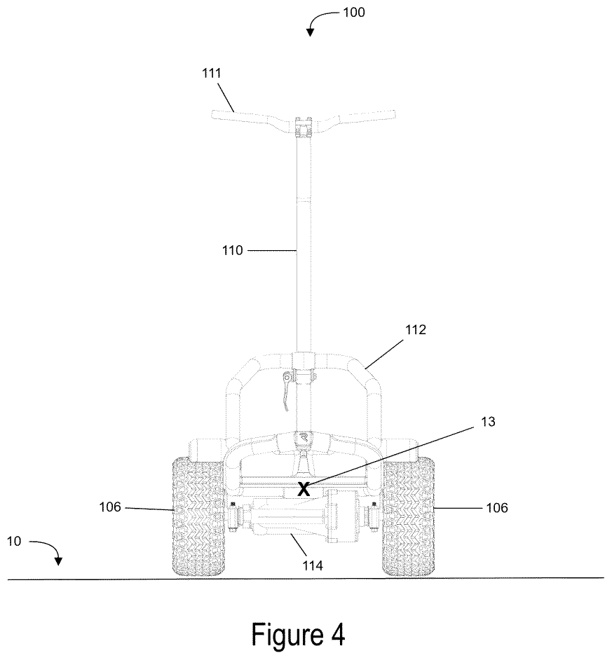

Referring to FIG. 4, the front view of the mobility vehicle 100 illustrates the structural arrangement and component positioning when viewed from the forward direction. The mobility vehicle 100 includes ground engaging members 106 positioned on either side of the vehicle structure. A motor 114 may be positioned between the ground engaging members 106, creating a centralized power source configuration that can provide driven movement to the mobility vehicle 100. The front support arm 112 may be positioned to provide structural connection between components while maintaining clearance for the operation of the ground engaging members 106 and motor 114.

The motor 114 may be operably coupled to one or more of the ground engaging members 106 to provide powered movement using the ground engaging members 106. In some cases, the motor 114 may comprise an electric motor that converts electrical energy into mechanical motion for propelling the mobility vehicle 100. The motor 114 may be secured using mounting hardware that positions the motor 114 at an appropriate height and orientation relative to the ground engaging members 106 and other drivetrain components. In some cases, the motor 114 may be configured to operate at various speeds and torque levels to accommodate different operating conditions and terrain types.

The mobility vehicle 100 may incorporate various drive system configurations to provide powered movement through different combinations of the ground engaging members 106. In one example, the mobility vehicle 100 may be configured as a front wheel drive system where a front motor may be operably coupled to the at least one front ground engaging member 106 to provide powered movement using the at least one front ground engaging member 106. This front wheel drive configuration may position the motor 114 on or near the front deck 102, allowing the front ground engaging members 106 to pull the mobility vehicle 100 forward while the rear ground engaging members 106 provide support and steering response.

Alternatively, the mobility vehicle 100 may be configured as a rear wheel drive system where a rear motor may be operably coupled to the at least one rear ground engaging member 106 to provide powered movement using the at least one rear ground engaging member 106. In this rear wheel drive configuration, the motor 114 may be positioned on or near the rear deck 104, allowing the rear ground engaging members 106 to push the mobility vehicle 100 forward while the front ground engaging members 106 provide steering input and directional control.

The mobility vehicle 100 may also be configured as an all-wheel drive system where the one or more motors 114 may comprise both a front motor operably coupled to the at least one front ground engaging member 106 to provide powered movement using the at least one front ground engaging member 106 and a rear motor operably coupled to the at least one rear ground engaging member 106 to provide powered movement using the at least one rear ground engaging member 106. This all-wheel drive configuration may provide powered movement to both the front deck 102 and rear deck 104 simultaneously, enhancing traction and mobility capabilities across various terrain conditions. The all-wheel drive system may allow for independent control of the front and rear motors, enabling differential power distribution between the front deck 102 and rear deck 104 based on operating conditions or operator input. In some cases, the all-wheel drive configuration may provide enhanced climbing ability, improved stability on uneven surfaces, and increased maneuverability through coordinated control of both the front and rear ground engaging members 106.

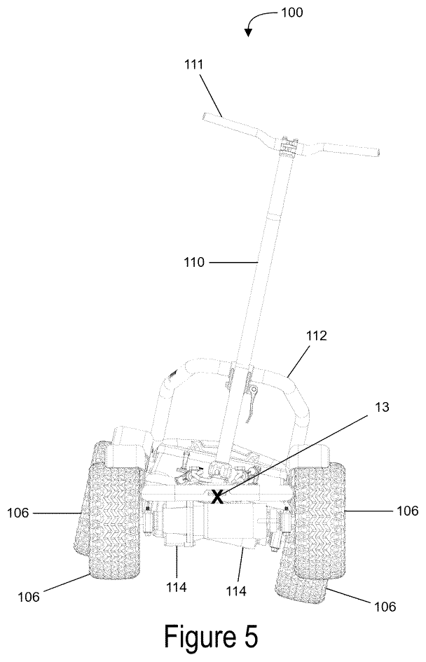

Referring to FIG. 5, the mobility vehicle 100 demonstrates roll movement capability with the front deck 102 rolled with respect to the rear deck 104. The front deck 102 may be rollably coupled to the rear deck 104 about a roll axis 13 that may be substantially parallel to the ground surface. This roll axis 13 may extend longitudinally through the mobility vehicle 100, allowing the front deck 102 to rotate relative to the rear deck 104 in a manner that accommodates uneven terrain or surface variations. The roll coupling may enable the front deck 102 and rear deck 104 to maintain contact with the ground surface through their respective ground engaging members 106 even when traversing surfaces that are not level or uniform.

The roll range about the roll axis 13 between the front deck 102 and the rear deck 104 may be limited to less than 270 degrees to prevent excessive rotation that could compromise the structural integrity or operational safety of the mobility vehicle 100. In some cases, the roll range may be limited to between about 10 degrees and 358 degrees, providing a wide range of articulation while maintaining practical operational boundaries. The roll range may also be limited to less than 240 degrees, less than 200 degrees, less than 180 degrees, less than 140 degrees, less than 100 degrees, or less than 50 degrees. The limitation of the roll range may be achieved through mechanical constraints built into the joint 108 or through separate limiting mechanisms that restrict the rotational movement between the front deck 102 and rear deck 104. In some cases, at least one bump stop may be incorporated to limit the roll range to less than 270 degrees.

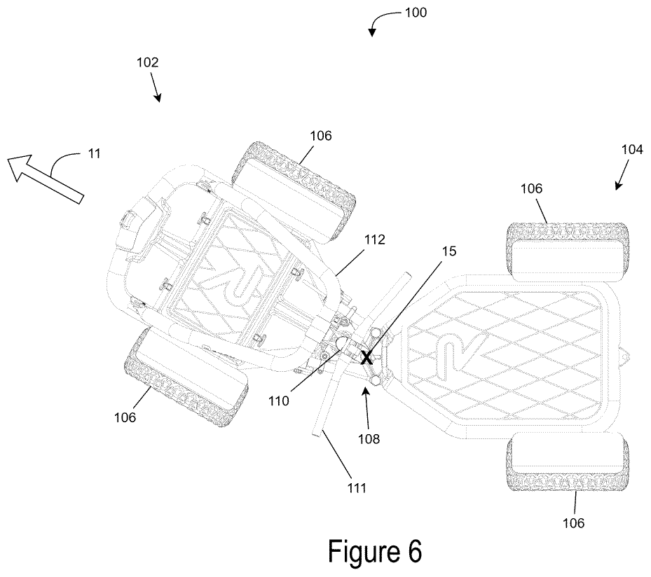

Referring to FIG. 6, the mobility vehicle 100 demonstrates pivotal movement capability with the front deck 102 pivoted with respect to the rear deck 104. The joint 108 operatively connects the front deck 102 and the rear deck 104, enabling the front deck 102 to be pivotally coupled to the rear deck 104 about a pivot axis 15 that may be orthogonal to both the direction of travel and the ground surface. This pivot axis 15 may extend vertically through the joint 108, creating a rotational relationship that allows the front deck 102 to rotate horizontally relative to the rear deck 104 while maintaining structural continuity between the two deck sections. The pivotal coupling may enable the mobility vehicle 100 to change direction by rotating the front deck 102 relative to the rear deck 104, with the pivot axis 15 serving as the center of rotation for steering movements.

The pivot range about the pivot axis 15 between the front deck 102 and the rear deck 104 may be limited to less than 270 degrees to prevent excessive rotation that could compromise the structural integrity or operational safety of the mobility vehicle 100. In some cases, the pivot range may be limited to between about 40 degrees and 270 degrees. The pivot range may also be limited to less than 240 degrees, less than 200 degrees, less than 180 degrees, less than 140 degrees, less than 100 degrees, or less than 50 degrees. The limitation of the pivot range may prevent the front deck 102 from rotating to positions where the ground engaging members 106 or other components might interfere with each other. The pivot range limitation may be achieved through mechanical constraints built into the joint 108 or through separate limiting mechanisms that restrict the rotational movement between the front deck 102 and rear deck 104. In some cases, at least one bump stop may be incorporated to limit the pivot range to less than 270 degrees, providing physical contact surfaces that prevent excessive rotation while allowing normal steering articulation during operation.

As shown in FIG. 6, the pivotal movement between the front deck 102 and rear deck 104 may create an angular relationship where the longitudinal axes of the two decks are no longer parallel, demonstrating the steering capability of the mobility vehicle 100. The joint 108 may accommodate the pivotal movement while maintaining the rollable coupling between the front deck 102 and rear deck 104 about a roll axis that may be substantially parallel to the ground surface.

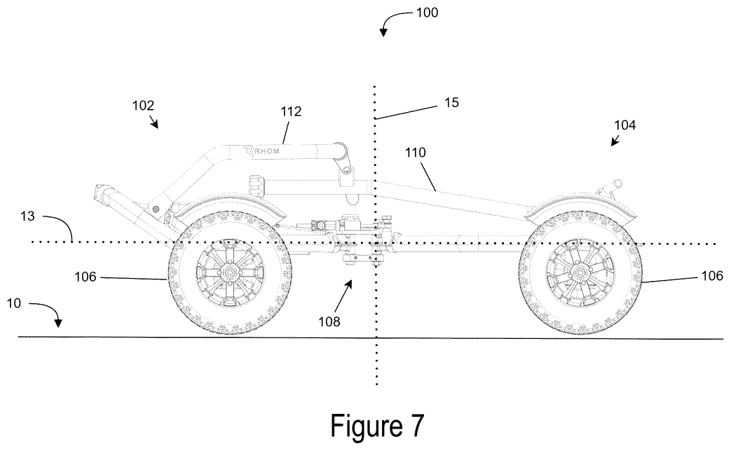

Referring to FIG. 7, the mobility vehicle 100 may be configured in a storage configuration that provides a compact arrangement of components for transport or storage purposes. The front deck 102 and rear deck 104 may maintain their structural connection through the joint 108 while allowing for repositioning of other components to achieve the storage configuration.

The steerable member 110 may be configured to be operatively disconnected from the front deck 102 to move into a storage position that reduces the vertical profile of the mobility vehicle 100. The operative disconnection of the steerable member 110 from the front deck 102 may involve releasing mechanical connections or fasteners that normally secure the steerable member 110 in the operational position. In some cases, the disconnection process may be designed to be reversible, allowing the steerable member 110 to be reconnected to the front deck 102 when the mobility vehicle 100 is returned to operational configuration.

The front support arm 112 may also be configured to accommodate the pivotal movement of the steerable member 110, allowing the front support arm 112 to fold or adjust its position in coordination with the steerable member 110 during the transition to the storage configuration. In some embodiments, the pivotal coupling may include detents or locking mechanisms that secure the steerable member 110 in the storage position to prevent unintended movement during transport or storage.

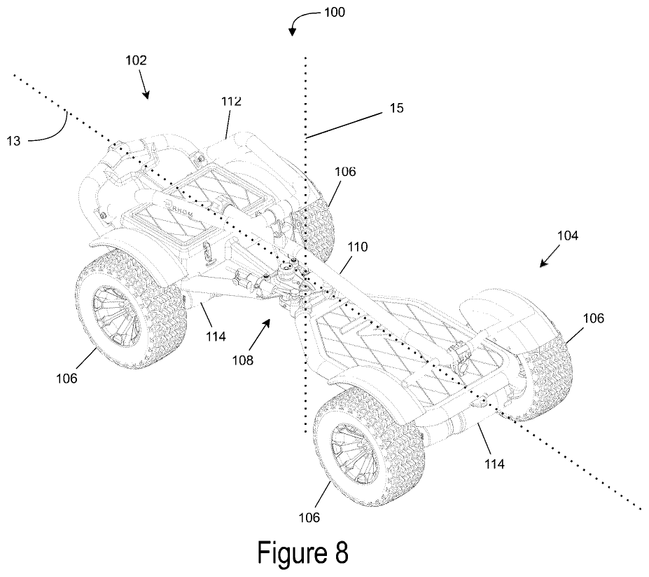

Referring to FIG. 8, the perspective view of the mobility vehicle 100 in the storage configuration. The front deck 102 and rear deck 104 may maintain their connection through the joint 108. The ground engaging members 106 may remain attached to their respective deck positions. The motors 114 may remain integrated with their respective deck assemblies, maintaining the drive system configuration.

The steerable member 110 and front support arm 112 may be repositioned in the storage configuration to reduce the vertical profile of the mobility vehicle 100. The repositioning of these components may involve pivotal movement or disconnection mechanisms that allow the steerable member 110 to fold down or rotate to a position closer to the front deck 102. The front support arm 112 may coordinate with the steerable member 110 during this repositioning process, maintaining structural relationships while accommodating the reduced vertical envelope of the storage configuration.

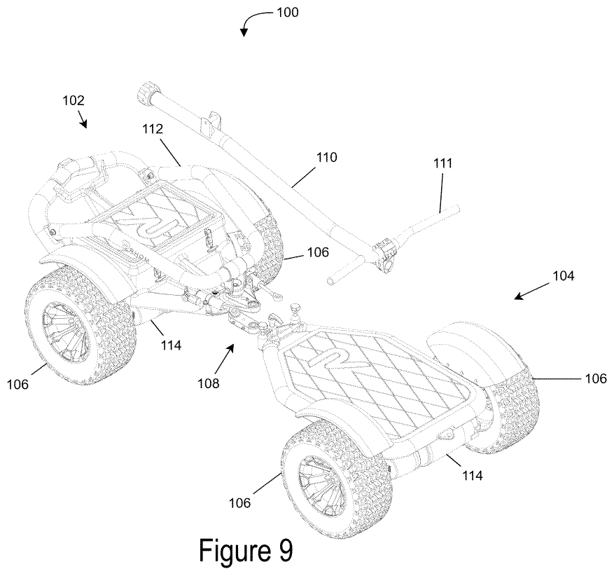

Referring to FIG. 9, the mobility vehicle 100 may be configured in a modular disassembly configuration where components may be decoupled. The modular disassembly configuration demonstrates the separable nature of the mobility vehicle 100, allowing the front deck 102 to be separated from the rear deck 104 through disconnection of the joint 108 that normally provides the operative connection between these two primary structural sections. The steerable member 110 may also be disconnected from the front deck 102, creating a third separable component that can be positioned independently of the deck assemblies. The front support arm 112 may maintain structural relationships with other components while accommodating the modular separation of the primary assemblies.

The joint 108 that normally connects the front deck 102 and rear deck 104 may incorporate quick-release mechanisms or removable fasteners that facilitate the separation process without requiring specialized tools or complex disassembly procedures. The separation process may be designed to be reversible, allowing the front deck 102 and rear deck 104 to be reconnected through reassembly of the joint 108 when the mobility vehicle 100 may be returned to operational configuration.

The steerable member 110 may be disconnected from the front deck 102 through release mechanisms that allow the steerable member 110 to be removed as a separate component for independent storage or transport. The disconnection of the steerable member 110 may involve releasing quick-release pins, removing threaded fasteners, or disengaging locking mechanisms that normally secure the steerable member 110 to the front deck 102.

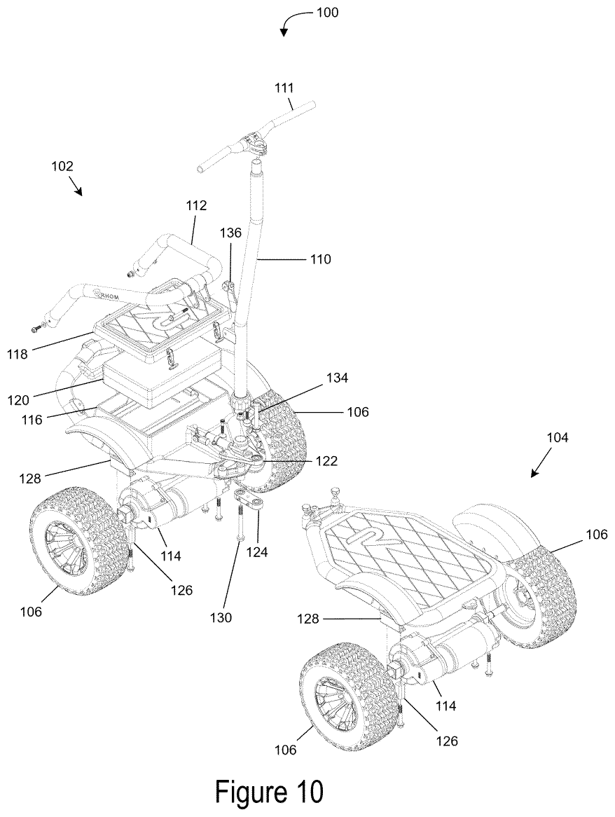

Referring to FIG. 10, the perspective, exploded view of the mobility vehicle 100 reveals the comprehensive assembly structure and component relationships that enable the operational capabilities of the mobility vehicle 100. As described for FIG. 1-9, mobility vehicle 100 consists of a front deck 102, rear deck 104, steerable member 110, ground engaging members 106, motors 114, an operator interface 111, and front support arm 112. FIG. 10 illustrates in more detail the assembly of the aforementioned elements in more detail.

The mobility vehicle 100 incorporates a battery compartment 116 that may be configured to house electrical power storage components. The battery compartment 116 may be positioned within one of the deck assemblies to provide centralized power storage while maintaining balanced weight distribution across the mobility vehicle 100. A battery compartment lid 118 may be configured to provide secure closure for the battery compartment 116, protecting the internal components from environmental exposure. The battery compartment lid 118 may incorporate sealing features or latching mechanisms that maintain the integrity of the battery compartment 116 during operation while facilitating convenient access when needed. A battery 120 may be housed within the battery compartment 116, providing electrical power for the motors 114 and other electrical systems of the mobility vehicle 100. The battery 120 may be configured as a removable component, allowing the battery 120 to be extracted from the battery compartment 116 for charging, replacement, or maintenance operations.

In the embodiment shown, the joint 108 that connects the front deck 102 and the rear deck 104 includes, or incorporates, an upper linkage 122 that may form part of the articulation mechanism enabling movement between the deck assemblies. The upper linkage 122 may be configured to provide structural connection while accommodating the pivotal and rollable movement capabilities between the front deck 102 and rear deck 104. The upper linkage 122 may extend between connection points on the front deck 102 and rear deck 104, creating a load path that maintains structural continuity while allowing controlled articulation. The joint 108 may further include a lower linkage 124 that works in conjunction with the upper linkage 122 to create a multi-point connection system that enables the desired movement characteristics between the front deck 102 and rear deck 104. The lower linkage 124 may be positioned at a different elevation or location relative to the upper linkage 122, creating a distributed connection system that provides stability and control during articulation movements. The combination of the upper linkage 122 and lower linkage 124 may create a linkage system that defines the pivot axis and roll axis relationships between the front deck 102 and rear deck 104.

The motor integration system includes motor brackets 126 that may provide mounting interfaces for securing the motors 114 to the deck assemblies. The motor brackets 126 may incorporate mounting features that accommodate the motor dimensions while providing secure attachment to the deck structures. Motor mounts 128 may work in conjunction with the motor brackets 126 to create a complete motor mounting. Motor brackets 126 and motor mounts 128 may be manufactured out of suitable materials (e.g., metal, composites, plastic, etc.) to accommodate the load of the mobility vehicle 100 with an operator. The motor mounts 128 may provide additional support points or vibration isolation features. The motor mounts 128 may be configured to accommodate different motor sizes or configurations, providing flexibility in the drive system design while maintaining consistent mounting interfaces with the deck assemblies.

The assembly incorporates various fastening components including linkage bolts 130 that may secure the upper linkage 122 and lower linkage 124 to their respective connection points on the front deck 102 and rear deck 104. The linkage bolts 130 may be configured to provide secure mechanical connection while allowing for the articulation movements enabled by the joint system. The linkage bolts 130 may incorporate features such as shoulder bolts or specialized fastener designs that maintain connection integrity while accommodating the rotational movements of the linkage components. Pivot bolts 134 may provide additional connection points within the joint system, enabling specific rotational relationships between components while maintaining structural continuity. The pivot bolts 134 may be positioned to define pivot axes or to provide bearing surfaces for rotational movements within the joint assembly. In one or more embodiments, the pivot bolts 134 may utilize quick-release fasteners for ease of disassembly and re-assembly.

A support release 136 may be incorporated into the assembly to provide adjustment or disconnection capabilities for the steerable member 110 relative to the front deck 102. The support release 136 may enable the steerable member 110 to be repositioned for storage configurations or to be completely disconnected for modular disassembly operations. The support release 136 may incorporate quick-release mechanisms, threaded fasteners, or locking systems that allow controlled adjustment of the steerable member 110 position.

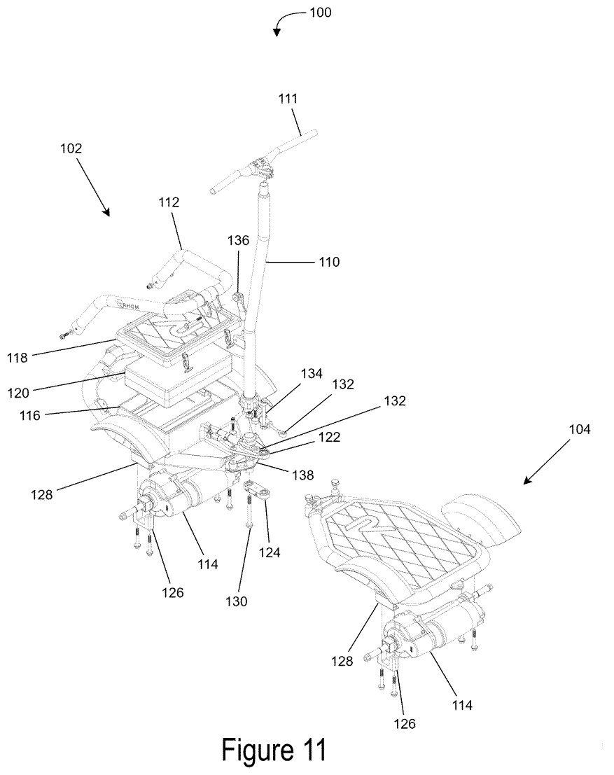

Referring to FIG. 11, the perspective, exploded view of the mobility vehicle 100 without wheels reveals the internal structural and mechanical components that enable the articulation and control capabilities of the mobility vehicle 100. FIG. 11 incorporates elements described in FIG. 1-10 with additional details provided herein.

The joint 108 may consist of a damper 132 that may be operatively connected to the front deck 102 and the rear deck 104 to reduce a rate of pivotal movement between the front deck 102 and the rear deck 104 about the pivot axis 15. The damper 132 may comprise a hydraulic damper that utilizes fluid resistance to provide consistent damping characteristics across various operating conditions and movement speeds. In another example, the damper 132 may comprise a mechanical damper with an internal spring system to provide resistance. The damper 132 may include an outer body defining a cavity and coupled to the rear deck 104, with a piston extending from the cavity of the outer body and coupled to the front deck 102, creating a telescoping arrangement that accommodates the relative movement between the deck sections while providing controlled resistance.

The damper 132 may define a linear damping coefficient range between specific values that provide appropriate resistance characteristics for the operational requirements of the mobility vehicle 100. In some cases, the damper 132 may define a linear damping coefficient range between about 1 N/(m/s) and about 20,000 N/(m/s), providing a range of resistance characteristics that can accommodate different operating conditions and operator preferences. In one embodiment, the at least one damper may define, or have, a rotational damping coefficient range between about 0.004 Nm/(radians/second) and about 500 Nm/(radians/second). The damper 132 may also be configured as an adjustable damper that may be adjustable by the operator, allowing the damping characteristics to be modified based on operating conditions, terrain requirements, or operator preferences.

The mobility vehicle 100 may incorporate two or more dampers 132, with each of the two or more dampers 132 configured to reduce the rate of pivotal movement between the front deck 102 and the rear deck 104 about the pivot axis 15 in both clockwise and counterclockwise directions. The dampers 132 may be positioned on opposite sides of the joint assembly or at different locations relative to the pivot axis 15. In one embodiment, it may be described that the dampers 132 include two dampers symmetrically arranged about the pivot axis 15 and are bidirectional.

A joint mount 138 may provide structural support and connection interfaces for the joint assembly components that enable the articulation between the front deck 102 and rear deck 104. The joint mount 138 may be positioned to support the upper linkage 122, lower linkage 124, and associated connection hardware while maintaining the precise geometric relationships that define the pivot axis and roll axis characteristics of the joint system. The joint mount 138 may incorporate mounting features that accommodate the linkage bolts 130, pivot bolts 134, and other fastening components while providing secure attachment to the deck structures. In some cases, the joint mount 138 may provide mounting interfaces for the dampers 132, positioning the dampers 132 at appropriate locations.

The upper linkage 122 may be pivotally and rollably coupled to both the front deck 102 and the rear deck 104. The lower linkage 124 may be fixedly coupled to the rear deck 104 and pivotally and rollably coupled to the front deck 102.

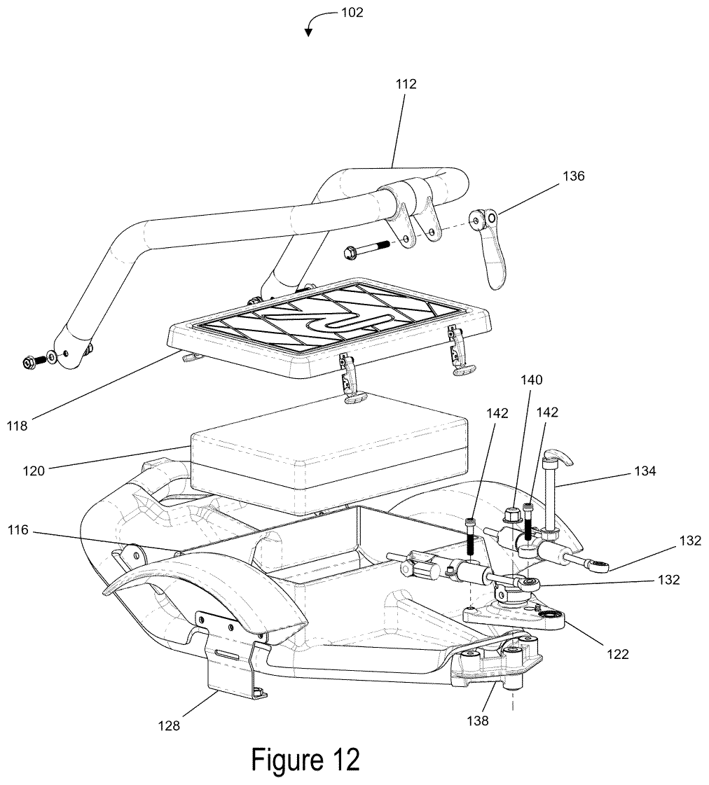

Referring to FIG. 12, the perspective, exploded view of a front portion of the mobility vehicle reveals the detailed construction and assembly relationships of the front deck 102 and associated components that enable the operational capabilities of the front section. FIG. 12 incorporates by reference elements described in FIGS. 1-11. FIG. 12 illustrates further detail of the front deck 102 and joint 108.

The front assembly incorporates dampers 132, as described in FIG. 11, which are coupled to the front deck 102 by damper bolts 142 which allow dampers 132 to rotate about the damper bolt. Damper bolts 142 provide additional support for the upper linkage 122 as they pass through dampers 132, the upper linkage 122 and mount into the joint mount 138. Additionally, upper linkage is mounted to the joint mount 138 by a linkage bolt 130 (not shown) fastened by a linkage nut 140. The linkage bolt 130, linkage nut 140, and damper bolts 142 fasten the joint assembly together while allowing articulation of the joint.

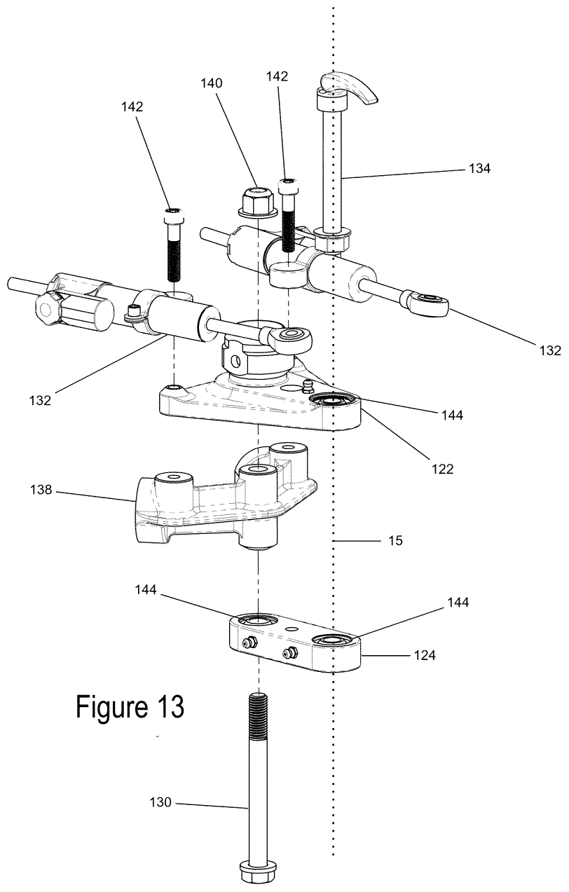

Referring to FIG. 13, the joint mechanism of the mobility vehicle 100 incorporates a sophisticated linkage system that enables controlled articulation between the front deck 102 and rear deck 104 through multiple connection configurations. FIG. 13 incorporated by reference elements described in FIGS. 1-12. FIG. 13 illustrates further detail of the joint assembly.

The joint 108 may comprise an upper linkage 122 and a lower linkage 124, with each of the upper linkage 122 and the lower linkage 124 operatively coupled to both the front deck 102 and the rear deck 104.

The upper linkage 122 may be fixedly connected to the front deck 102 and pivotally and rollably connected to the rear deck 104. In this configuration, the upper linkage 122 may maintain a rigid connection to the front deck 102 while allowing controlled rotational movement relative to the rear deck 104 through bearing interfaces that accommodate both pivotal and rollable motion. The lower linkage 124 may be pivotally and rollably connected to the front deck 102 and pivotally and rollably connected to the rear deck 104, creating a symmetric connection arrangement where the lower linkage 124 can rotate relative to both deck assemblies through bearing interfaces at each connection point. The bearing system within the joint mechanism may incorporate bearings 144. The bearing 144 may be, at least, bushings or spherical bearings which allow pivot and roll movement within the joint 108. Joint components may be manufactured by various methods (e.g., CNC, casting, laminating, etc.) with various materials (e.g., metals, composites, etc.). Additionally, it is to be understood that such bearings 144 may include (e.g., formed of, defined by, etc.) compliant, or resilient, material to, e.g., providing damping and responsiveness, and increased stability by absorbing vibrations and noise (NVH).

### EXAMPLES

Example Ex1: A mobility vehicle to move over a ground surface in a direction of travel comprising:
a front deck comprising at least one front ground engaging member;
a rear deck comprising:
   at least one rear ground engaging member; and
   an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein a pivot range about the pivot axis between the front deck and the rear deck is limited to less than 270 degrees, wherein the front deck is rollably coupled to the rear deck about a roll axis that is substantially parallel to the ground surface, wherein a roll range about the roll axis between the front deck and the rear deck is limited to less than 270 degrees; and
a steerable member operatively connected to the front deck and configured to pivot the front deck relative to the rear deck by an operator on the operator platform to steer the vehicle.

Example Ex2: The vehicle of Example Ex1, wherein the pivot range is limited to less than 70 degrees and the roll range is limited to less than 50 degrees.

Example Ex3: The vehicle of Example Ex1, wherein the joint comprises an upper linkage and a lower linkage, and each of the upper linkage and the lower linkage operatively coupled to both the front deck and the rear deck.

Example Ex4: The vehicle of Example Ex3, wherein the upper linkage is fixedly connected to the front deck and pivotally and rollably connected to the rear deck, and wherein the lower linkage is pivotally and rollably connected to the front deck and pivotally and rollably connected to the rear deck.

Example Ex5: The vehicle of Example Ex3, wherein the upper linkage is fixedly connected to the front deck and pivotally and rollably connected to the rear deck using an upper spherical bearing, and wherein the lower linkage is pivotally and rollably connected to the front deck using a lower front spherical bearing and pivotally and rollably connected to the rear deck using a lower rear spherical bearing.

Example Ex6: The vehicle of Example Ex3, wherein the upper linkage is fixedly connected to the front deck and pivotally and rollably connected to the rear deck using an upper compliant bushing, and wherein the lower linkage is pivotally and rollably connected to the front deck using a lower front spherical bearing and pivotally and rollably connected to the rear deck using a lower compliant bushing.

Example Ex7: The vehicle of Example Ex1, wherein the steerable member is configured operatively disconnected from front deck to move into a storage position.

Example Ex8: The vehicle of Example Ex7, wherein the steerable member is pivotally coupled to the front deck to pivot into the storage position when operatively disconnected from front deck.

Example Ex9: The vehicle of Example Ex1, further comprising a front support arm coupled to the front deck and the steerable member.

Example Ex 10: The vehicle of Example Ex1, further comprising at least one damper operatively connected to the front deck and the rear deck to reduce a rate of pivotal movement between the front deck and the rear deck about the pivot axis.

Example Ex11: The vehicle of Example Ex1, further comprising at least one bump or at least one damper stop to limit the pivot range to less than 270 degrees.

Example Ex 12: The vehicle of Example Ex1, further comprising at least one bump stop or at least one damper to limit the roll range to less than 270 degrees.

Example Ex13: The vehicle of Example Ex1, wherein the one or more motors comprises an electric motor.

Example Ex 14: The vehicle of Example Ex1, wherein the one or more motors comprises a front motor operably coupled to the at least one front ground engaging member to provide powered movement using the at least one front ground engaging member.

Example Ex 15: The vehicle of Example Ex1, wherein the one or more motors comprises a rear motor operably coupled to the at least one rear ground engaging member to provide powered movement using the at least one rear ground engaging member.

Example Ex 16: The vehicle of Example Ex1, wherein the one or more motors comprises:
a front motor operably coupled to the at least one front ground engaging member to provide powered movement using the at least one front ground engaging member; and
a rear motor operably coupled to the at least one rear ground engaging member to provide powered movement using the at least one rear ground engaging member.

Example Ex 17: A mobility vehicle to move over a ground surface in a direction of travel comprising:
a front deck comprising at least one front ground engaging member;
a rear deck comprising:
   at least one rear ground engaging member; and
   an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein the front deck is rollably coupled to the rear deck about a roll axis that is substantially parallel to the ground surface;
at least one damper operatively connected to the front deck and the rear deck to reduce a rate of pivotal movement between the front deck and the rear deck about the pivot axis; and
a steerable member operatively connected to the front deck and configured to pivot the front deck relative to the rear deck by an operator on the operator platform to steer the vehicle.

Example Ex18: The vehicle of Example Ex17, wherein the at least one damper defines rotational damping coefficient between about 0.004 Nm/radians/second and about 500 Nm/radians/second.

Example Ex19: The vehicle of Example Ex17, wherein the at least one damper comprises an adjustable damper that is adjustable by the operator.

Example Ex20: The vehicle of Example Ex17, wherein the at least one damper comprises two or more dampers, each of the two or more dampers configured to reduce the rate of pivotal movement between the front deck and the rear deck about the pivot axis in a clockwise and counterclockwise direction.

Example Ex21: The vehicle of Example Ex17, wherein the at least one damper is a hydraulic damper.

Example Ex22: The vehicle of Example Ex17, wherein the at least one damper comprises:
an outer body defining a cavity and coupled to the rear deck; and
a piston extending from the cavity of the outer body and coupled to the front deck.

Example Ex23: The vehicle of Example Ex17, wherein the joint comprises an upper linkage and a lower linkage, and each of the upper linkage and the lower linkage operatively coupled to both the front deck and the rear deck.

Example Ex24: The vehicle of Example Ex23, wherein the upper linkage is fixedly connected to the front deck and pivotally and rollably connected to the rear deck, and wherein the lower linkage is pivotally and rollably connected to the front deck and pivotally and rollably connected to the rear deck.

Example Ex25: The vehicle of Example Ex23, wherein the upper linkage is fixedly connected to the front deck and pivotally and rollably connected to the rear deck using an upper spherical bearing, and wherein the lower linkage is pivotally and rollably connected to the front deck using a lower front spherical bearing and pivotally and rollably connected to the rear deck using a lower rear spherical bearing.

Example Ex26: The vehicle of Example Ex23, wherein the upper linkage is fixedly connected to the front deck and pivotally and rollably connected to the rear deck using an upper compliant bushing, and wherein the lower linkage is pivotally and rollably connected to the front deck using a lower front spherical bearing and pivotally and rollably connected to the rear deck using a lower compliant bushing.

Example Ex27: The vehicle of Example Ex17, wherein the steerable member is configured operatively disconnected from front deck to move into a storage position.

Example Ex28: The vehicle of Example Ex27, wherein the steerable member is pivotally coupled to the front deck to pivot into the storage position when operatively disconnected from front deck.

Example Ex29: The vehicle of Example Ex 17, further comprising a front support arm coupled to the front deck and the steerable member.

Example Ex30: The vehicle of Example Ex17, wherein the one or more motors comprises an electric motor.

Example Ex31: The vehicle of Example Ex17, wherein the one or more motors comprises a front motor operably coupled to the at least one front ground engaging member to provide powered movement using the at least one front ground engaging member.

Example Ex32: The vehicle of Example Ex17, wherein the one or more motors comprises a rear motor operably coupled to the at least one rear ground engaging member to provide powered movement using the at least one rear ground engaging member.

Example Ex33: The vehicle of Example Ex17, wherein the one or more motors comprises:
a front motor operably coupled to the at least one front ground engaging member to provide powered movement using the at least one front ground engaging member; and
a rear motor operably coupled to the at least one rear ground engaging member to provide powered movement using the at least one rear ground engaging member.

Example Ex34: A mobility vehicle to move over a ground surface in a direction of travel comprising:
a front deck comprising at least one front ground engaging member;
a rear deck comprising:
   at least one rear ground engaging member; and
   an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein the front deck is rollably coupled to the rear deck about a roll axis that is substantially parallel to the ground surface, wherein the joint comprises an upper linkage and a lower linkage, and each of the upper linkage and the lower linkage operatively coupled to both the front deck and the rear deck; and
a steerable member operatively connected to the front deck and configured to pivot the front deck relative to the rear deck by an operator on the operator platform to steer the vehicle.

Example Ex35: The vehicle of Example Ex34, wherein the upper linkage is fixedly connected to the front deck and pivotally and rollably connected to the rear deck, and wherein the lower linkage is pivotally and rollably connected to the front deck and pivotally and rollably connected to the rear deck.

Example Ex36: The vehicle of Example Ex34, wherein the upper linkage is fixedly connected to the front deck and pivotally and rollably connected to the rear deck using an upper spherical bearing, and wherein the lower linkage is pivotally and rollably connected to the front deck using a lower front spherical bearing and pivotally and rollably connected to the rear deck using a lower rear spherical bearing.

Example Ex37: The vehicle of Example Ex34, wherein the upper linkage is fixedly connected to the front deck and pivotally and rollably connected to the rear deck using an upper compliant bushing, and wherein the lower linkage is pivotally and rollably connected to the front deck using a lower front spherical bearing and pivotally and rollably connected to the rear deck using a lower compliant bushing.

Example Ex38: The vehicle of Example Ex34, wherein the steerable member is configured operatively disconnected from front deck to move into a storage position.

Example Ex39: The vehicle of Example Ex38, wherein the steerable member is pivotally coupled to the front deck to pivot into the storage position when operatively disconnected from front deck.

Example Ex40: The vehicle of Example Ex34, further comprising a front support arm coupled to the front deck and the steerable member.

Example Ex41: The vehicle of Example Ex34, further comprising at least one damper operatively connected to the front deck and the rear deck to reduce a rate of pivotal movement between the front deck and the rear deck about the pivot axis.

Example Ex42: The vehicle of Example Ex34, wherein the one or more motors comprises an electric motor.

Example Ex43: The vehicle of Example Ex34, wherein the one or more motors comprises a front motor operably coupled to the at least one front ground engaging member to provide powered movement using the at least one front ground engaging member.

Example Ex44: The vehicle of Example Ex34, wherein the one or more motors comprises a rear motor operably coupled to the at least one rear ground engaging member to provide powered movement using the at least one rear ground engaging member.

Example Ex45: The vehicle of Example Ex34, wherein the one or more motors comprises:
a front motor operably coupled to the at least one front ground engaging member to provide powered movement using the at least one front ground engaging member; and
a rear motor operably coupled to the at least one rear ground engaging member to provide powered movement using the at least one rear ground engaging member.

All references and publications cited herein are expressly incorporated herein by reference in their entirety for all purposes, except to the extent any aspect directly contradicts this disclosure.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

As used herein, the term “configured to” may be used interchangeably with the terms “adapted to” or “structured to” unless the content of this disclosure clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

A number of implementations have been described. Nevertheless, it will be understood that various modifications may be made without departing from the spirit and scope of the disclosure. Accordingly, other implementations are within the scope of the following claims.

What is claimed is:

1. A mobility vehicle to move over a ground surface in a direction of travel comprising:
a front deck comprising at least one front ground engaging member;
a rear deck comprising:
at least one rear ground engaging member; and
an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein a pivot range about the pivot axis between the front deck and the rear deck is limited to less than 270 degrees, wherein the front deck is rollably coupled to the rear deck about a roll axis that is substantially parallel to the ground surface, wherein a roll range about the roll axis between the front deck and the rear deck is limited to less than 270 degrees; and
a steerable member operatively connected to the front deck and configured to pivot the front deck relative to the rear deck by an operator on the operator platform to steer the vehicle.

2. The vehicle of claim 1, wherein the pivot range is limited to less than 70 degrees and the roll range is limited to less than 50 degrees.

3. The vehicle of claim 1, wherein the joint comprises an upper linkage and a lower linkage, and each of the upper linkage and the lower linkage operatively coupled to both the front deck and the rear deck.

4. The vehicle of claim 3, wherein the upper linkage is fixedly connected to the front deck and pivotally and rollably connected to the rear deck, and wherein the lower linkage is pivotally and rollably connected to the front deck and pivotally and rollably connected to the rear deck.

5. The vehicle of claim 3, wherein the upper linkage is fixedly connected to the front deck and pivotally and rollably connected to the rear deck using an upper spherical bearing, and wherein the lower linkage is pivotally and rollably connected to the front deck using a lower front spherical bearing and pivotally and rollably connected to the rear deck using a lower rear spherical bearing.

6. The vehicle of claim 3, wherein the upper linkage is fixedly connected to the front deck and pivotally and rollably connected to the rear deck using an upper compliant bushing, and wherein the lower linkage is pivotally and rollably connected to the front deck using a lower front spherical bearing and pivotally and rollably connected to the rear deck using a lower compliant bushing.

7. The vehicle of claim 1, wherein the steerable member is configured operatively disconnected from front deck to move into a storage position.

8. The vehicle of claim 1, further comprising at least one damper operatively connected to the front deck and the rear deck to reduce a rate of pivotal movement between the front deck and the rear deck about the pivot axis.

9. The vehicle of claim 1, further comprising at least one bump stop to limit the pivot range or roll range to less than 270 degrees.

10. The vehicle of claim 1, wherein the one or more motors comprises:
a front motor operably coupled to the at least one front ground engaging member to provide powered movement using the at least one front ground engaging member; and
a rear motor operably coupled to the at least one rear ground engaging member to provide powered movement using the at least one rear ground engaging member.

11. A mobility vehicle to move over a ground surface in a direction of travel comprising:
a front deck comprising at least one front ground engaging member;
a rear deck comprising:
at least one rear ground engaging member; and
an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein the front deck is rollably coupled to the rear deck about a roll axis that is substantially parallel to the ground surface;
at least one damper operatively connected to the front deck and the rear deck to reduce a rate of pivotal movement between the front deck and the rear deck about the pivot axis; and
a steerable member operatively connected to the front deck and configured to pivot the front deck relative to the rear deck by an operator on the operator platform to steer the vehicle.

12. The vehicle of claim 11, wherein the at least one damper defines rotational damping coefficient between 0.004 Nm/radians/second and 500 Nm/radians/second.

13. The vehicle of claim 11, wherein the at least one damper comprises an adjustable damper that is adjustable by the operator.

14. The vehicle of claim 11, wherein the at least one damper comprises two or more dampers, each of the two or more dampers configured to reduce the rate of pivotal movement between the front deck and the rear deck about the pivot axis in a clockwise and counterclockwise direction.

15. The vehicle of claim 11, wherein the at least one damper is a hydraulic damper.

16. The vehicle of claim 11, wherein the joint comprises an upper linkage and a lower linkage, and each of the upper linkage and the lower linkage operatively coupled to both the front deck and the rear deck.

17. A mobility vehicle to move over a ground surface in a direction of travel comprising:
a front deck comprising at least one front ground engaging member;
a rear deck comprising:
at least one rear ground engaging member; and
an operator platform;
one or more motors operably coupled to one or more of the at least one front ground engaging member and the at least one rear ground engaging member to provide powered movement using one or more of the at least one front ground engaging member and the at least one rear ground engaging member;
a joint operatively connecting the front deck and the rear deck, wherein the front deck is pivotally coupled to the rear deck about a pivot axis that is orthogonal to both the direction of travel and the ground surface, wherein the front deck is rollably coupled to the rear deck about a roll axis that is substantially parallel to the ground surface, wherein the joint comprises an upper linkage and a lower linkage, and each of the upper linkage and the lower linkage operatively coupled to both the front deck and the rear deck; and
a steerable member operatively connected to the front deck and configured to pivot the front deck relative to the rear deck by an operator on the operator platform to steer the vehicle.

18. The vehicle of claim 17, wherein the upper linkage is fixedly connected to the front deck and pivotally and rollably connected to the rear deck, and wherein the lower linkage is pivotally and rollably connected to the front deck and pivotally and rollably connected to the rear deck.

19. The vehicle of claim 17, wherein the upper linkage is fixedly connected to the front deck and pivotally and rollably connected to the rear deck using an upper spherical bearing, and wherein the lower linkage is pivotally and rollably connected to the front deck using a lower front spherical bearing and pivotally and rollably connected to the rear deck using a lower rear spherical bearing.

20. The vehicle of claim 17, wherein the upper linkage is fixedly connected to the front deck and pivotally and rollably connected to the rear deck using an upper compliant bushing, and wherein the lower linkage is pivotally and rollably connected to the front deck using a lower front spherical bearing and pivotally and rollably connected to the rear deck using a lower compliant bushing.
